(19) United States
(12) Patent Application Publication
(10) Pub. No.: US 2015/0011105 A1
(43) Pub. Date: Jan. 8, 2015

(54) LEVER CONNECTOR

(71) Applicant: YAZAKI CORPORATION, Tokyo (JP)

(72) Inventor: Jun Kamiya, Aichi (JP)

(21) Appl. No.: 14/378,818

(22) PCT Filed: Feb. 20, 2013
(86) PCT No.: PCT/JP2013/054189

§ 371 Date: Aug. 14, 2014

(30) Foreign Application Priority Data
Feb. 20, 2012 (JP) 2012-034170

(51) Int. Cl. H01R 13/629

(52) U.S. Cl. CPC H01R 13/62933
USPC 439/153

(57) ABSTRACT

A second connector housing (20) includes shaft guiding slots (22) in which lever supporting shafts (11) of a first connector housing (10) are fitted movably along a direction in which the connector housings are fitted with each other, and action receiving shafts (23) at a pair of opposed side walls (21a) of an outer sheath wall part (21) with which the first connector housing (10) is fitted, and a fitting lever (30) which is pivotably installed to the first connector housing includes shaft engaging slots (32) which the lever bodies (31) are formed with and have a straight line shape so that both the lever supporting shafts (11) which are inserted through the shaft guiding slots (22) and the action receiving shafts (23) are embedded, and a force point part (33) which receive an operating force when the lever bodies (31) are pivoted around the lever supporting shafts (11).

### TECHNICAL FIELD

The present invention relates to a lever connector.

### BACKGROUND ART

FIG. 15 shows an example of traditional lever connectors.

This lever connector 100 which is disclosed in a PTL1 below includes a first connector housing 110, a second connector housing 120 which is fitted and connected with the first connector housing 110, and a fitting lever 130 which is pivotably installed to the first connector housing 110.

The second connector housing 120 has an outer sheath wall part (hood part) 121 into which the first connector housing 110 is inserted.

The fitting lever 130 is a member by which an operating force to fit/detach the first connector housing 110 into/from the second connector housing 120 can be reduced, and is pivotably installed to shafts 111 which are protruded from the outer side surfaces of the first connector housing 110.

As shown in the figure, the fitting lever 130 includes a pair of lever bodies 131 which are arranged to be opposite to each other so that a pair of outer side surfaces of the first connector housing 110 are sandwiched, a joint member 132 that connects the pair of lever bodies 131 at one end side, pivot fulcrum holes 133 which are formed in the lever bodies 131 and are pivotably engaged with the shafts 111 on the outer side surfaces of the first connector housing 110, and action point protruding parts 134 which are engaged with lever retaining holes 122 which are formed at the outer side surfaces of the outer sheath wall part 121 when a fitting operation begins after the first connector housing 110 and the second connector housing 120 are aligned to a fitting start position.

In the illustrated example, the joint member 132 also serves as a force point part which receives the operating force when the lever bodies 131 are pivoted around the shafts 111.

For the lever connector 100 of the PTL1, the first connector housing 110 is fitted and connected with the second connector housing 120 with the following steps.

First, as shown in the figure, the fitting lever 130 is pivotably attached to the first connector housing 110. Then, as shown by an arrow X1 in FIG. 15, the front end of the first connector housing 110 is inserted into the outer sheath wall part 121 of the second connector housing 120, the first connector housing 110 and the second connector housing 120 are aligned to the fitting start position, and the action point protruding parts 134 of the fitting-operation lever 130 are engaged with the lever retaining holes 122 of the second connector housing 120.

Then, the joint member 132 of the fitting lever 130 is pressed down, and as shown by the arrow R1 in FIG. 15, the fitting lever 130 is pivoted. The second connector housing 120 is drawn toward the first connector housing 110 with the pivoting movement of the fitting-operation lever 130, and the fitting of the connector housings with each other is completed.

When the connector housings fitted with each other are to be detached, the joint member 132 is pivoted in a direction opposite to the direction shown by the arrow R1 in FIG. 15 so that the connector housings are detached from each other.

### CITATION LIST

### Patent Literature

PTL1: Japanese Patent No. 3442661

### SUMMARY OF THE INVENTION

### Problem to be Solved by the Invention

However, in the case of the lever connector 100 of the PTL1, the fitting lever 130 cannot be removed from the first connector housing 110 when the connector housings are fitted with each other.

Therefore, in the case of the lever connector 100 of the PTL1, even when the connector housings are actually used after the connector housings are fitted and connected with each other, the weight of the fitting lever 130 is added so that the weight of the connector is increased.

In the case of the lever connector 100 of the PTL1, the lever connector 100 must be accompanied by the fitting lever 130, and there is a problem which is that the cost is increased because of the increase of the component number.

The object of the present invention is to solve the above problems and provide a lever connector which makes it possible to reduce the cost due to the reduction of the component number and reduce the weight in a use state.

### Solution to Problem

The above-mentioned object of the present invention is achieved by the following constructions.

(1) A lever connector includes a first connector housing, a second connector housing which is fitted and connected with the first connector housing, and a fitting lever which is pivotably installed to the first connector housing as a lever member to reduce the operating force to fit and detach the first connector housing with and from the second connector housing. The first connector housing includes lever supporting shafts which are respectively protruded from a pair of outer surfaces to support the fitting lever to be pivotable, the second connector housing includes a sheath wall part which is fitted with the circumference of the first connector housing, shaft guiding slots which are formed by cutting a pair of opposed side walls of the sheath wall part along a direction in which the connector housings are fitted with each other and into which, when the connector housings are fitted with each other, the lever supporting shafts are fitted movably along the direction in which the connector housings are fitted with each other, and action receiving shafts which are protruded from the outer surfaces of the side walls, which are formed with the shaft guiding slots, and are located with a predetermined distance from the shaft guiding slots in a direction perpendicular to the direction in which the connector housings are fitted with each other, the fitting lever includes a pair of lever bodies which are arranged to be opposed to each other to sandwich the outside surfaces of the pair of side walls of the second connector housing which is formed with the shaft guiding slots, shaft engaging slots which are formed into a straight line shape on the inner surfaces of the pair of lever bodies so that when the pair of lever bodies are inserted and installed to the pair of side walls, both the lever supporting shafts, which are inserted through the shaft guiding slots, and the action receiving shafts are embedded in the shaft engaging slots, and a force point part which receives an operation force to make the lever bodies pivot around the lever supporting shafts, and the fitting lever is pivoted while the lever supporting shafts and the action receiving shafts are engaged in the shaft engaging slots to make the connector housings move along the direction in which the connector housings are fitted with each other.

(2) In the lever connector of (1), the fitting lever includes insertion regulating protrusions on the inner surfaces of the lever bodies to regulate the insertion direction to the second connector housing, the second connector housing includes first insertion guiding surfaces, second insertion guiding surfaces and guiding change parts at the pair of side walls which are formed with the shaft guiding slots, the first insertion guiding surfaces are equipped so that when the fitting lever is inserted to and detached from the second connector housing while the first connector housing and the second connector housing are aligned at a fitting start position, the movement direction of the lever bodies is regulated to the direction of a straight line which links the lever supporting shafts in the shaft guiding slots and the action receiving shafts by the sliding contact of the insertion regulating protrusions, the second insertion guiding surfaces are equipped so that when the fitting lever is inserted to and detached from the second connector housing while the first connector housing and the second connector housing are aligned at a fitting end position, the movement direction of the lever bodies is regulated to the direction of a straight line which links the lever supporting shafts in the shaft guiding slots and the action receiving shafts due to the sliding contact of the insertion regulating protrusions, and the guiding change parts join the ends of the first insertion guiding surfaces and the ends of the second insertion guiding surfaces so that while the lever supporting shafts and the action receiving shafts are embedded in the shaft engaging slots, the insertion regulating protrusions can move back and forth between a first guiding end position after the insertion regulating protrusions pass the first insertion guiding surfaces and a second guiding end position after the insertion regulating protrusions pass the second insertion guiding surfaces.

(3) In the lever connector of (2), the guiding change parts have protrusion sliding surfaces against which the insertion regulating protrusions abut to regulate the fitting lever from moving away from the second connector housing.

According to the construction of the above (1), for the fitting lever, when the fitting lever is pivoted while the lever supporting shafts and the action receiving shafts are engaged in the shaft engaging slots which the lever bodies are formed with and have a straight line shape, since the fitting lever is pivoted around the lever supporting shafts, the parts of the shaft engaging slots that contact the action receiving shafts function as action points of a lever that produces a force in the fitting direction of the connector housings, the force in the fitting direction of the connector housing acts on the action receiving shafts, and the connector housings can be fitted and connected with each other or can be detached from each other.

According to the construction of the above (1), for the fitting lever, in either of the fitting start state which is that the first connector housing and the second connector housing are aligned at the fitting start position and the fitting end state which is that the connector housings have been fitted and connected with each other, by inserting the fitting lever to the second connector housing to direct the fitting lever to the second connector housing so that the extending direction of the shaft engaging slots coincides with the straight line that links the lever supporting shafts which are protruded from the shaft guiding slots of the second connector housing and the action receiving shafts, it is possible to easily become an installed state which is that the fitting lever is engaged with the first connector housing and the second connector housing.

Further, in either of the fitting start state and the fitting end state, by pulling out the fitting lever, which has been installed to the first connector housing and the second connector housing, from the second connector housing along the extending direction of the shaft engaging slots, it is possible to easily return to a state which is that the fitting lever is disengaged from the first connector housing and the second connector housing.

That is, according to the construction of the above (1), since after the connector housings have been fitted with each other, the fitting lever is disengaged from the connector housings, a reduction in weight can be realized in an use state of the connector.

The disengaged fitting lever can be used in fitting other lever connectors. Therefore, the component set of a regular lever connector only includes the first connector housing and the second connector housing but does not include the fitting lever, so that the cost can be reduced due to the reduction of the component number.

According to the construction of the above (2), while the first connector housing and the second connector housing in the fitting start state or the fitting end state, when the fitting lever is inserted/detached to/from the first connector housing and the second connector housing, since the insertion regulating protrusions, which the fitting lever is equipped with, slide on the first insertion guiding surfaces or the second insertion guiding surfaces, the movement direction of the lever bodies is regulated to the direction of a straight line that links the lever supporting shafts and the action receiving shafts, and vibration of the lever bodies is prevented.

Therefore, it is possible to smoothly and easily insert/detach the fitting lever to/from the connector housing.

According to the construction of the above (3), in the middle of fitting the connector housings with each other, since the insertion regulating protrusions which the fitting lever is equipped with are located within the guiding change parts of the second connector housing, and the insertion regulating protrusions abut against the protrusion sliding surfaces, the fitting lever is regulated from moving away from the second connector housing so that the fitting lever cannot be disengaged.

That is, according to the construction of the above (3), if after the operation of fitting the connector housings with each other is completed, the fitting lever cannot be disengaged from the connector housings, the connector housings are in the middle of fitting (half fitted state), it is possible to determine the fitted state of the connector housings with the disengaging operation of the fitting lever, and it can be prevented that poor fitting of the connector housings with each other is overlooked.

### Effect of the Invention

According to the lever connector of the present invention, after the connector housings have been fitted with each other, the fitting lever is disengaged from the connector housings so that a reduction in weight can be realized in an use state of the connector.

The disengaged fitting lever can be used in fitting other lever connectors. Therefore, the component set of a regular lever connector only includes the first connector housing and the second connector housing but does not include the fitting lever, so that the cost can be reduced due to the reduction of the component number.

The invention has been briefly described above. Further, details of the present invention will become more apparent after embodiments of the invention described below (hereinafter referred to as “embodiments”) are read with reference to the accompanying figures.

### BRIEF DESCRIPTION OF DRAWINGS

FIG. 1 is an exploded perspective view of a lever connector according to one embodiment of the present invention.

FIG. 2 is a side view of a first connector housing shown in FIG. 1.

FIG. 3 is a side view of a second connector housing shown in FIG. 1.

FIG. 4 is a front view of a fitting lever shown in FIG. 1.

FIG. 5 is an A-A sectional view of FIG. 4.

FIG. 6 is a perspective view which indicates a state before the fitting lever is installed to a second connector housing after a first connector housing is aligned at a fitting start position.

FIG. 7 is a perspective view which indicates a state while the fitting lever is installed to the second connector housing after the first connector housing is aligned at the fitting start position.

FIG. 8 is a side view of the lever connector shown in FIG. 7.

FIG. 9 is a perspective view which indicates a state while the fitting lever is pivoted in the arrow R2 direction of FIG. 7 from the state shown in FIG. 7, and the first connector housing and the second connector housing have been fitted and connected.

FIG. 10 is a side view of the lever connector which indicates the movement of insertion regulating protrusions of the fitting lever when the connector housings move from the fitting start position to a fitting end position with the pivoting of the fitting lever.

FIG. 11 is a perspective view which indicates an operation of pulling out the fitting lever from the connector housings which have been fitted.

FIG. 12 is a side view which indicates a state before the fitting lever is installed again to the connector housings which have been fitted.

FIG. 13 is a side view of the lever connector while the fitting lever is installed again by being inserted into the arrow X4 direction of FIG. 12 from the state shown in FIG. 12.

FIG. 14 is a side view of the lever connector while the connector housings are returned to the fitting start position when the fitting lever, which is installed again to the second connector housing, is pivoted in the arrow R3 direction of FIG. 13.

FIG. 15 is an exploded perspective view of a conventional lever connector.

### DESCRIPTION OF EMBODIMENTS

A preferred embodiment of the lever connector according to the present invention is described in detail with reference to the figures as follows.

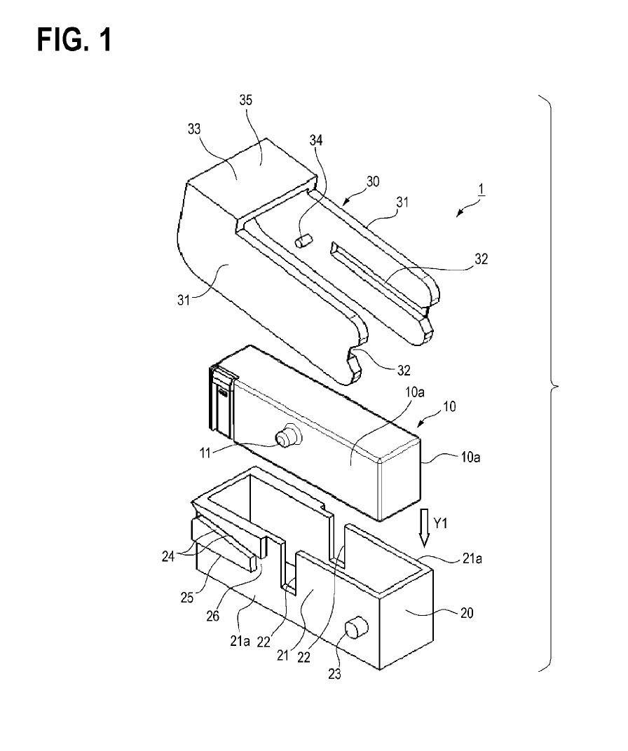

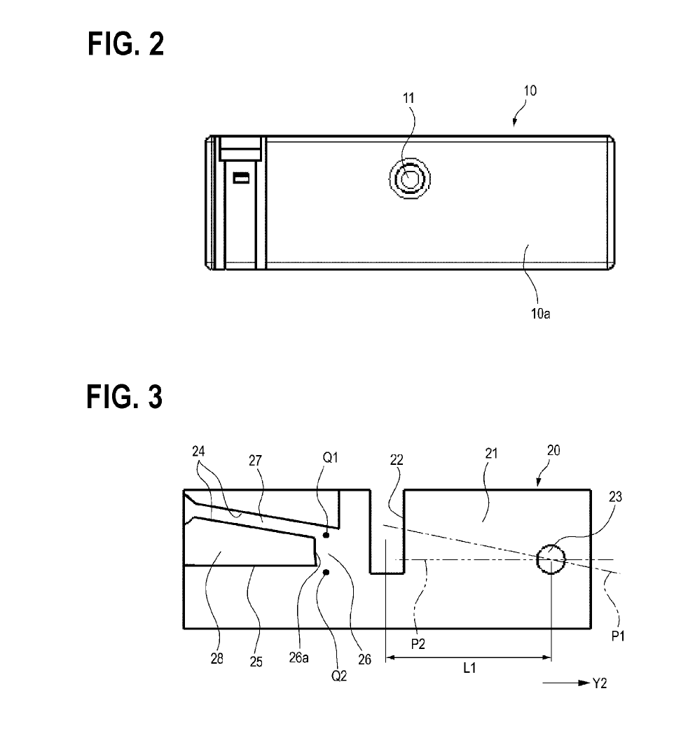

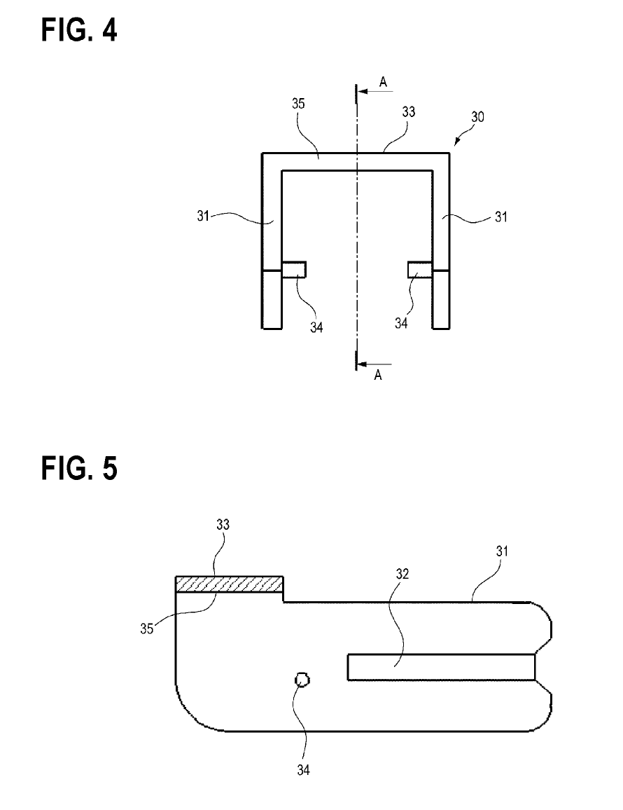

FIGS. 1 to 5 show a lever connector according to one embodiment of the present invention. FIG. 1 is an exploded perspective view of the lever connector of the embodiment. FIG. 2 is a side view of a first connector housing shown in FIG. 1. FIG. 3 is a side view of a second connector housing shown in FIG. 1. FIG. 4 is a front view of a fitting lever shown in FIG. 1. FIG. 5 is an A-A sectional view of FIG. 4.

As shown in FIG. 1, a lever connector 1 of the present embodiment includes a first connector housing 10, a second connector housing 20 which is fitted and connected with the first connector housing 10, and a fitting lever 30 which is pivotably installed to the first connector housing 10.

As shown in FIGS. 1 and 2, lever supporting shafts 11 are respectively protruded from a pair of outside surfaces 10a of the first connector housing 10. The lever supporting shafts 11 are cylindrical shafts (boss parts) which support the fitting lever 30 to be pivotable.

The second connector housing 20 includes a rectangular pipe-like outer sheath wall part (hood part) 21 into which the outer circumference of the first connector housing 10 is fitted. Furthermore, at a pair of opposite side walls 21a of the outer sheath wall part 21, the second connector housing 20 includes shaft guiding slots 22, action receiving shafts 23, first insertion guiding surfaces 24, second insertion guiding surfaces 25 and guiding change parts 26.

The shaft guiding slots 22 are slots which are formed by cutting the side walls 21a to extend along the direction (the arrow Y1 direction in FIG. 1) in which the connector housings are fitted with each other. The shaft guiding slots 22 are slots into which, when the connector housings are fitted with each other, the lever supporting shafts 11 of the first connector housing 10 are fitted movably along the direction in which the connector housings are fitted with each other.

As shown in FIG. 3, the action receiving shafts 23 are protruded from the outer surfaces of the side walls 21a, and are located with a predetermined distance L1 from the shaft guiding slots 22 in the direction (arrow Y2 direction of FIG. 3) perpendicular to the direction in which the connector housings are fitted with each other. The action receiving shafts 23 have a cylindrical shape with the same outer diameter as that of the lever supporting shafts 11 of the first connector housing 10.

The first insertion guiding surfaces 24 are surfaces that extend in parallel with a straight line P1 shown in FIG. 3. The straight line P1 is a straight line which links the lever supporting shafts 11 in the shaft guiding slots 22 and the action receiving shafts 23 while the first connector housing 10 and the second connector housing 20 are aligned at a fitting start position as shown in FIG. 8.

The first insertion guiding surfaces 24 are equipped so that when the fitting lever 30 is inserted/detached to/from the second connector housing 20 while the first connector housing 10 and the second connector housing 20 are aligned at the fitting start position, the movement direction of the lever bodies 31 is regulated to the direction of the straight line P1 due to the sliding contact of insertion regulating protrusions 34 to be described later.

In the present embodiment, as shown in FIG. 3, a pair of the first insertion guiding surfaces 24 are provided so that, the insertion regulating protrusions 34 to be described later are sandwiched to be slidable in the direction of the straight line P1. That is, a pair of the first insertion guiding surfaces 24 form guiding grooves 27 which guide the insertion regulating protrusions 34 to be described later in the direction of the straight line P1.

The second insertion guiding surfaces 25 are surfaces that extend in parallel with a straight line P2 shown in FIG. 3. The straight line P2 is a straight line which links the lever supporting shafts 11 in the shaft guiding slots 22 and the action receiving shafts 23 while the first connector housing 10 and the second connector housing 20 are aligned at a fitting end position as shown in FIG. 10.

The second insertion guiding surfaces 25 are equipped so that when the fitting lever 30 is inserted/detached to/from the second connector housing 20 while the first connector housing 10 and the second connector housing 20 are aligned at the fitting end position, the movement direction of the lever bodies 31 is regulated to the direction of the straight line P2 due to the sliding contact of insertion regulating protrusions 34 to be described later.

In the present embodiment, thee second insertion guiding surfaces 25 are the lower end surfaces of ridges 28 which the above-mentioned guiding grooves 27 are formed with.

The guiding change parts 26 are parts where the fitting lever 30 is pivotable while the lever supporting shafts 11 and the action receiving shafts 23 are embedded in shaft engaging slots 32 of the fitting lever 30 to be described later.

Specifically, the guiding change parts 26 are parts which join the ends of the first insertion guiding surfaces 24 and the ends of the second insertion guiding surfaces 25 so that while the lever supporting shafts 11 and the action receiving shafts 23 are embedded in the shaft engaging slots 32 of the fitting lever 30 to be described later, as shown in FIG. 3, the insertion regulating protrusions 34 to be described later can move back and forth between a first guiding end position Q1 after the insertion regulating protrusions 34 pass the first insertion guiding surfaces 24 and a second guiding end position Q2 after the insertion regulating protrusions 34 pass the second insertion guiding surfaces 25.

In the present embodiment, the guiding change parts 26 have protrusion sliding surfaces 26a as shown in FIG. 3. The protrusion sliding surfaces 26a regulate the movement of the fitting lever 30 to the direction away from the second connector housing 20 when the insertion regulating protrusions 34 of the fitting lever 30 abut against the protrusion sliding surfaces 26a.

The fitting lever 30 is a member by which an operating force to fit/detach the first connector housing 10 into/from the second connector housing 20 can be reduced, and is pivotably installed to the first connector housing 10.

As shown in FIGS. 4 and 5, the fitting lever 30 in the present embodiment includes a pair of lever bodies 31, shaft engaging slots 32, a force point part 33 and insertion regulating protrusions 34.

The pair of lever bodies 31 are arranged to be opposed to each other to sandwich the outside surfaces of the pair of side walls 21a of the second connector housing 20 where the shaft guiding slots 22 are formed. One end sides of the pair of lever bodies 31 are joined by a connecting plate 35 so that the opposed state is kept.

The shaft engaging slots 32 are slots whose width is so set that the lever supporting shafts 11 and the action receiving shafts 23 may be inserted through, and are formed on the inner surfaces of the pair of lever bodies 31 into a linear shape. The shaft engaging slots 32 open at the distal ends of the lever bodies 31 so that when the pair of lever bodies 31 are inserted and installed to the pair of side walls 21a, both the lever supporting shafts 11, which are inserted through the shaft guiding slots 22, and the action receiving shafts 23 are embedded in the shaft engaging slots 32.

The force point part 33 is a part which receives an operation force to make the lever bodies 31 pivot around the lever supporting shafts 11. The force point part 33 of the present embodiment is the outer surface of the connecting plate 35 which joins the pair of lever bodies 31.

The insertion regulating protrusions 34 are protruded from the inner surfaces of the lever bodies 31. While the fitting lever 30 is inserted/detached to/from the second connector housing 20, the insertion regulating protrusions 34 slide on the first insertion guiding surfaces 24 or the second insertion guiding surfaces 25 which the second connector housing 20 is equipped with to regulate the insertion direction relative to the second connector housing 20.

For the lever connector 1 of the present embodiment, the fitting lever 30 is pivoted while the lever supporting shafts 11 and the action receiving shafts 23 are engaged in the shaft engaging slots 32 of the fitting lever 30 to make the connector housings move to/from each other in the fitting direction.

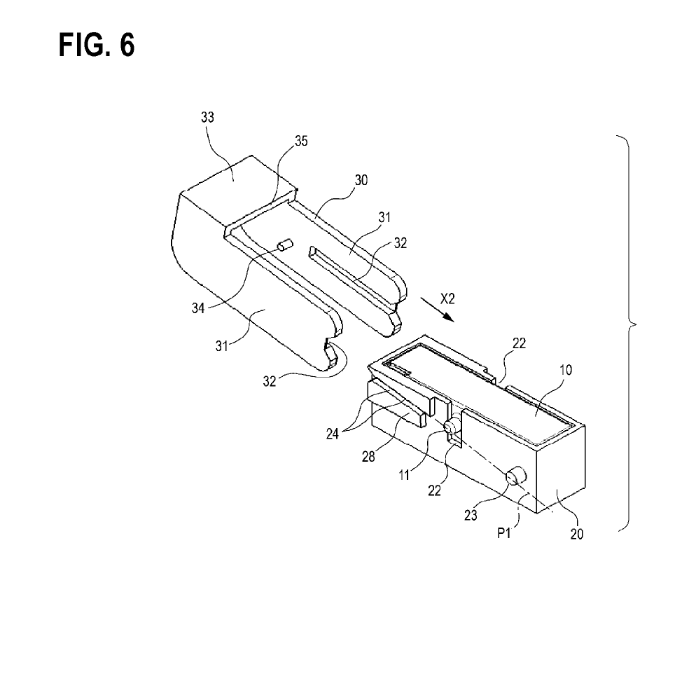

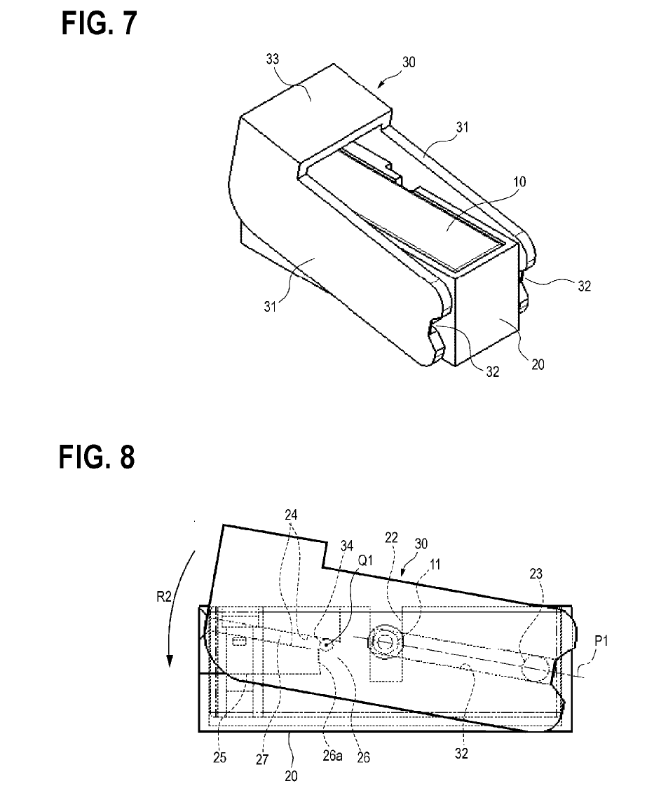

Next, a method of fitting and connecting the connector housings with each other and a detaching method with the fitting lever 30 after the fitting and connecting in the lever connector 1 of the present embodiment are described based on FIGS. 6 to 14.

When the connector housings are to be fitted and connected with each other, initially, as shown in FIG. 6, the first connector housing 10 is inserted in the outer sheath wall part 21 of the second connector housing 20, and the connector housings are aligned at the fitting start position. Then, as shown with the arrow X2 in FIG. 6, the fitting lever 30 is inserted and installed to the second connector housing 20 aligned at the fitting start position.

The direction of the arrow X2 shown in FIG. 6 is a direction along the straight line P1 which links the lever supporting shafts 11 which are protruded from the shaft guiding slots 22 and the action receiving shafts 23.

When the fitting lever 30 is inserted into the second connector housing 20, the fitting lever 30 is pushed until the lever supporting shafts 11 abut against the ends of the shaft engaging slots 32. As a result, as shown in FIG. 8, inside the shaft engaging slots 32, both the lever supporting shafts 11 and the action receiving shafts 23 become embedded in the shaft engaging slots 32.

When the fitting lever 30 is inserted and installed to the second connector housing 20 which is aligned at the fitting start position, the insertion regulating protrusions 34 of the fitting lever 30 are inserted into the guiding grooves 27 which have a pair of the first insertion guiding surfaces 24. Then, at the time of the insertion of the fitting lever 30, the insertion regulating protrusions 34 slide on the first insertion guiding surfaces 24, the movement direction of the fitting lever 30 is regulated so that vibration does not occur in the lever bodies 31, and the inserting operation becomes easy.

When the fitting lever 30 is inserted to the second connector housing 20 until the lever supporting shafts 11 abut against the ends of the shaft engaging slots 32, as shown in FIG. 8, the insertion regulating protrusions 34 reach the first guiding end position Q1 which is a position after the insertion regulating protrusions 34 pass the first insertion guiding surfaces 24.

Then, as shown with the arrow R2 in FIG. 8, the fitting lever 30 is pivoted to make the first connector housing 10 and the second connector housing 20 change from the fitting start state to a fitting end state. When the fitting lever 30 is pivoted around the lever supporting shafts 11 from the state shown in FIG. 8, the contact part of the shaft engaging slots 32 and the action receiving shafts 23 works as a point of action to act a force in the fitting direction on the action receiving shafts 23, and the mutual fitting of the connector housings is deepened.

With the pivoting of the fitting lever 30, as shown with the arrow Y4 in FIG. 10, the insertion regulating protrusions 34 of the fitting lever 30 moves toward the second guiding end position Q2 of the guiding change parts 26. The second guiding end position Q2 is a position after the second insertion guiding surfaces 25 is passed.

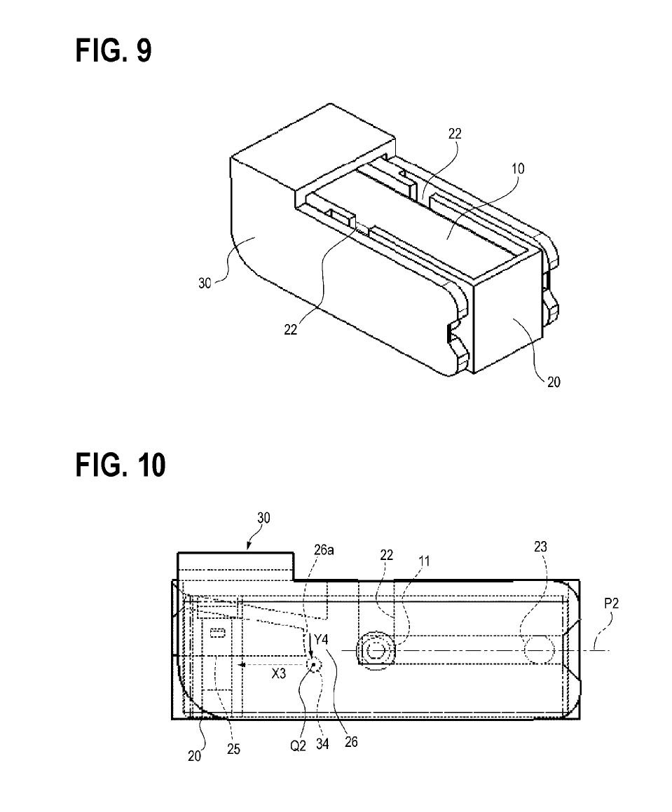

As shown in FIGS. 9 and 10, when the pivoting of the fitting lever 30 is completed, the first connector housing 10 and the second connector housing 20 haven been fitted and connected.

During the fitting of the connector housings (that is, during the pivoting of the fitting lever 30), the insertion regulating protrusions 34 are located in the middle of the guiding change parts 26. When the insertion regulating protrusions 34 moves in the guiding change parts 26, the insertion regulating protrusions 34 abut against the protrusion sliding surfaces 26a to regulate the fitting lever 30 from being disengaging from the second connector housing 20. Therefore, during the fitting of the connector housings, and the fitting lever 30 will not be disengaged.

While the connector housings have been fitted to each other with the pivoting of the fitting lever 30, as shown in FIG. 10, the insertion regulating protrusions 34 are located at the second guiding end position Q2 and become slidable on the second insertion guiding surfaces 25.

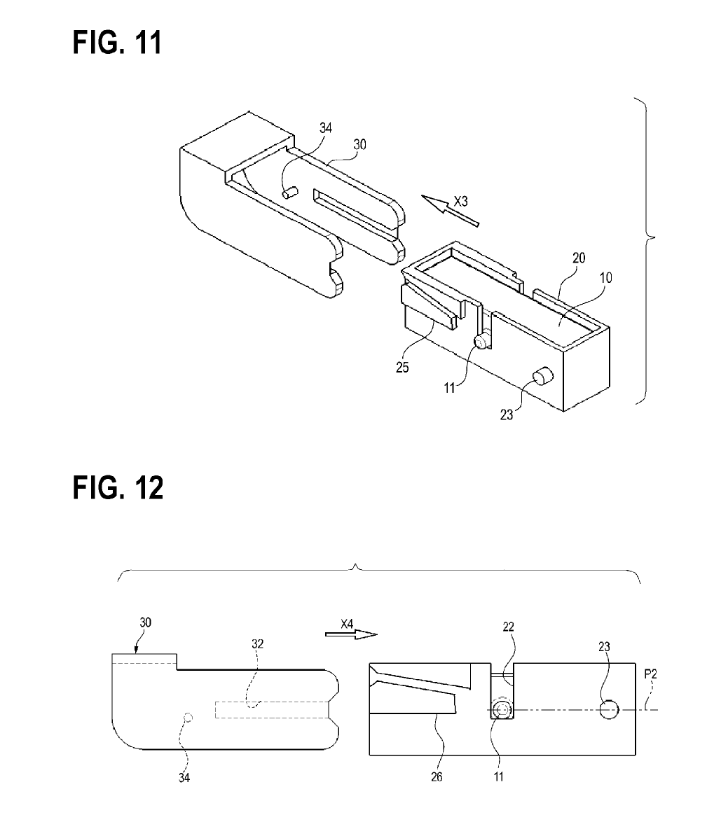

Therefore, as shown with the arrow X3 in FIGS. 10 and 11, when being pulled to the direction along the straight line P2, the insertion regulating protrusions 34 slide on the second insertion guiding surfaces 25, and the fitting lever 30 can be disengaged from the second connector housing 20.

When the fitting lever 30, which was removed from the second connector housing 20 after the connector housing had been fitted and connected with each other, is to be installed again, as shown with the arrow X4 in FIG. 12, the fitting lever 30 is inserted and installed to the second connector housing 20 along the straight line P2 which links the lever supporting shafts 11 and the action receiving shafts 23. At this time, because the moving direction of the fitting lever 30 is regulated along the direction of the straight line P2 by making the insertion regulating protrusions 34 slide in the guiding change parts 26, the inserting operation can be easy.

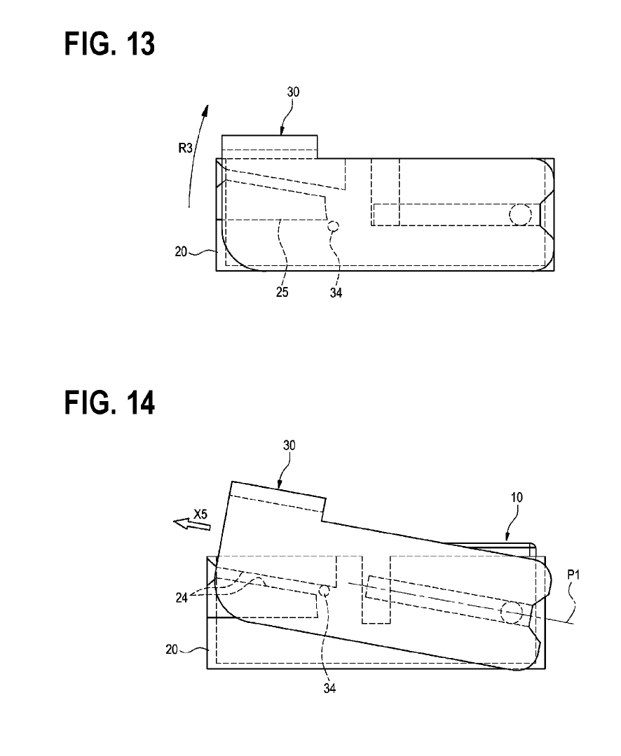

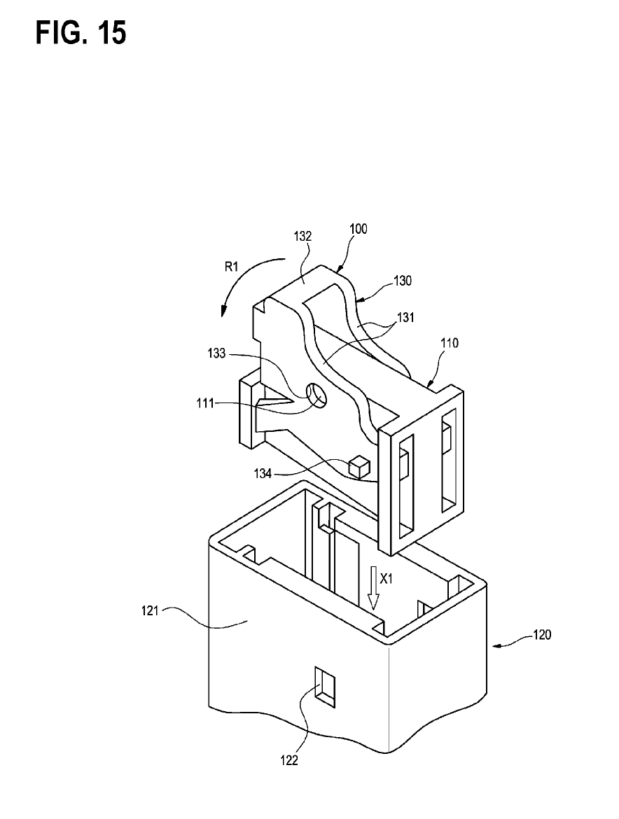

As shown in FIG. 13, after the fitting lever 30 has been installed to the second connector housing 20 again, as shown with the arrow R3 in FIG. 13, when the fitting lever 30 is pivoted reversely, as shown in FIG. 14, the connector housings are moved in the detaching direction to make it possible to return to the fitting start position from the state of being fitted with each other.

As shown in FIG. 14, while the connector housings are returned to the fitting start position, by pulling the fitting lever 30 to the direction of the straight line P1 as shown with the arrow X5 in FIG. 14, it is possible to return to the state of FIG. 6.

For the fitting lever 30 in the above-described lever connector 1 of the embodiment, when the fitting lever 30 is pivoted while the lever supporting shafts 11 and the action receiving shafts 23 are engaged in the shaft engaging slots 32 which the lever bodies 31 are formed with and have a straight line shape, since the fitting lever 30 is pivoted around the lever supporting shafts 11, the parts of the shaft engaging slots 32 that contact the action receiving shafts 23 function as action points of a lever that produces a force in the fitting direction of the connector housings, the force in the fitting direction of the connector housing acts on the action receiving shafts 23, and the connector housings can be fitted and connected with each other or can be detached from each other.

For the fitting lever 30 of the lever connector 1 of the embodiment, in either of the fitting start state which is that the first connector housing 10 and the second connector housing 20 are aligned at the fitting start position and the fitting end state which is that the connector housings have been fitted and connected with each other, by inserting the fitting lever 30 to the second connector housing 20 to direct the fitting lever 30 to the second connector housing 20 so that the extending direction of the shaft engaging slots 32 coincides with the straight line that links the lever supporting shafts 11 which are protruded from the shaft guiding slots 22 of the second connector housing 20 and the action receiving shafts 23, it is possible to easily become an installed state which is that the fitting lever 30 is engaged with the first connector housing 10 and the second connector housing 20.

In either of the fitting start state and the fitting end state, by pulling out the fitting lever 30, which has been installed to the first connector housing 10 and the second connector housing 20, from the second connector housing 20 along the extending direction of the shaft engaging slots 32, it is possible to easily return to a state which is that the fitting lever 30 is disengaged from the first connector housing 10 and the second connector housing 20.

That is, according to the construction of the above embodiment, since after the connector housings have been fitted with each other, the fitting lever 30 is disengaged from the connector housings, a reduction in weight can be realized in an use state of the connector.

The disengaged fitting lever 30 can be used in fitting other lever connectors. Therefore, the component set of a regular lever connector only includes the first connector housing 10 and the second connector housing 20 but does not include the fitting lever 30, so that the cost can be reduced by reducing the number of components.

Furthermore, for the lever connector 1 of the embodiment, while the first connector housing 10 and the second connector housing 20 are in the fitting start state or the fitting end state, when the fitting lever 30 is inserted/detached to/from the first connector housing 10 and the second connector housing 20, since the insertion regulating protrusions 34, which the fitting lever 30 is equipped with, slide on the first insertion guiding surfaces 24 or the second insertion guiding surfaces 25, the movement direction of the lever bodies 31 is regulated to the direction of a straight line that links the lever supporting shafts 11 and the action receiving shafts 23, and vibration of the lever bodies 31 is prevented.

Therefore, it is possible to smoothly and easily insert/detach the fitting lever 30 to/from the connector housing.

Furthermore, for the lever connector 1 of the embodiment, in the middle of fitting the connector housings with each other, since the insertion regulating protrusions 34 which the fitting lever 30 is equipped with are located within the guiding change parts 26 of the second connector housing 20, and the insertion regulating protrusions 34 abut against the protrusion sliding surfaces 26a, the fitting lever 30 is regulated from moving away from the second connector housing 20 so that the fitting lever 30 cannot be disengaged.

That is, according to the construction of the embodiment, if after the operation of fitting the connector housings with each other is completed, the fitting lever 30 cannot be disengaged from the connector housings, the connector housings are in the middle of fitting (half fitted state), it is possible to determine the fitted state of the connector housings with the disengaging operation of the fitting lever 30, and it can be prevented that poor fitting of the connector housings with each other is overlooked.

The present invention is not limited to the above-described embodiments, and suitable modifications, improvements and the like can be made. Moreover, the materials, shapes, dimensions, numbers, installation places, and the like of the components in the above embodiment are arbitrarily set as far as the invention can be attained, and not particularly restricted.

Although the invention is described in detail with reference to the specific embodiments, it is apparent that various modifications and amendments may be made by those skilled in the art without departing from the spirit and scope of the invention.

This application is based on the Japanese patent application (patent application No. 2012-034170) filed on Feb. 20, 2012, whose content is incorporated herein by reference.

The features of the lever connector according to the embodiment of the present invention described above are briefly, collectively listed in the following [1] to [3], respectively.

[1] A lever connector including:

a first connector housing (10),

a second connector housing (20) which is fitted and connected with the first connector housing (10), and

a fitting lever (30) which is pivotably installed to the first connector housing (10) as a lever member to reduce the operating force to fit/detach the first connector housing (10) with/from the second connector housing (20),

wherein the first connector housing (10) includes lever supporting shafts (11) which are respectively protruded from a pair of outer surfaces to support the fitting lever (30) to be pivotable,

the second connector housing (20) includes a sheath wall part (21) which is fitted with the circumference of the first connector housing (10), shaft guiding slots (22) which are formed by cutting a pair of opposed side walls (21a) of the sheath wall part (21) along a direction in which the connector housings are fitted with each other and into which, when the connector housings are fitted with each other, the lever supporting shafts (11) are fitted movably along the direction in which the connector housings are fitted with each other, and action receiving shafts (23) which are protruded from the outer surfaces of the side walls (21a), which are formed with the shaft guiding slots (22), and are located with a predetermined distance from the shaft guiding slots (22) in a direction perpendicular to the direction in which the connector housings are fitted with each other,

the fitting lever (30) includes a pair of lever bodies (31) which are arranged to be opposed to each other to sandwich the outside surfaces of the pair of side walls (21a) of the second connector housing (20) which is formed with the shaft guiding slots (22), shaft engaging slots (32) which are formed into a straight line shape on the inner surfaces of the pair of lever bodies (31) so that when the pair of lever bodies (31) are inserted and installed to the pair of side walls (21a), both the lever supporting shafts (11), which are inserted through the shaft guiding slots (22), and the action receiving shafts (23) are embedded in the shaft engaging slots (32), and a force point part (33) which receives an operation force to make the lever bodies (31) pivot around the lever supporting shafts (11), and

the fitting lever (30) is pivoted while the lever supporting shafts (11) and the action receiving shafts (23) are engaged in the shaft engaging slots (32) to make the connector housings move to/from each other in the direction in which the connector housings are fitted with each other.

[2] The lever connector recorded in the above [1], wherein the fitting lever (30) includes insertion regulating protrusions (34) on the inner surfaces of the lever bodies (31) to regulate the insertion direction to the second connector housing (20),

the second connector housing (20) includes first insertion guiding surfaces (24), second insertion guiding surfaces (25) and guiding change parts (26) at the pair of side walls (21a) which are formed with the shaft guiding slots (22),

the first insertion guiding surfaces (24) are equipped so that when the fitting lever (30) is inserted/detached to/from the second connector housing (20) while the first connector housing (10) and the second connector housing (20) are aligned at a fitting start position, the movement direction of the lever bodies (31) is regulated to the direction of a straight line which links the lever supporting shafts (11) in the shaft guiding slots (22) and the action receiving shafts (23) due to the sliding contact of the insertion regulating protrusions (34),

the second insertion guiding surfaces (25) are equipped so that when the fitting lever (30) is inserted/detached to/from the second connector housing (20) while the first connector housing (10) and the second connector housing (20) are aligned at a fitting end position, the movement direction of the lever bodies (31) is regulated to the direction of a straight line which links the lever supporting shafts (11) in the shaft guiding slots (22) and the action receiving shafts (23) due to the sliding contact of the insertion regulating protrusions (34), and

the guiding change parts (26) join the ends of the first insertion guiding surfaces (24) and the ends of the second insertion guiding surfaces (25) so that while the lever supporting shafts (11) and the action receiving shafts (23) are embedded in the shaft engaging slots (32), the insertion regulating protrusions (34) can move back and forth between a first guiding end position (Q1) after the insertion regulating protrusions (34) pass the first insertion guiding surfaces (24) and a second guiding end position (Q2) after the insertion regulating protrusions (34) pass the second insertion guiding surfaces (25).

[3] The lever connector recorded in the above [2], wherein the guiding change parts (26) have protrusion sliding surfaces (26a) against which the insertion regulating protrusions (34) abut to regulate the fitting lever (30) from moving away from the second connector housing (20).

### INDUSTRIAL APPLICABILITY

According to the lever connector of the present invention, after the connector housings have been fitted with each other, the fitting lever is disengaged from the connector housings so that a reduction in weight can be realized in an use state of the connector. The present invention which has the above effect is useful in the field of lever connector.

### REFERENCE SIGN LIST

1 lever connector

10 first connector housing

10a outside surface

11 lever supporting shaft

20 second connector housing

21 sheath wall part (hood part)

21a side wall

22 shaft guiding slot

23 action receiving shaft

24 first insertion guiding surface

25 second insertion guiding surface

26 guiding change part

26a protrusion sliding surface

30 fitting lever

31 lever body

32 shaft engaging slot

33 force point part

34 insertion regulating protrusion

Q1 first guiding end position

Q2 second guiding end position

1. A lever connector comprising:
a first connector housing;
a second connector housing which is fitted and connected with the first connector housing; and
a fitting lever which is pivotably installed to the first connector housing as a lever member to reduce the operating force to fit and detach the first connector housing with and from the second connector housing,
wherein the first connector housing includes lever supporting shafts which are respectively protruded from a pair of outer surfaces to support the fitting lever to be pivotable,
the second connector housing includes a sheath wall part which is fitted with the circumference of the first connector housing, shaft guiding slots which are formed by cutting a pair of opposed side walls of the sheath wall part along a direction in which the connector housings are fitted with each other and into which, when the connector housings are fitted with each other, the lever supporting shafts are fitted movably along the direction in which the connector housings are fitted with each other, and action receiving shafts which are protruded from the outer surfaces of the side walls, which are formed with the shaft guiding slots, and are located with a predetermined distance from the shaft guiding slots in a direction perpendicular to the direction in which the connector housings are fitted with each other,
the fitting lever includes a pair of lever bodies which are arranged to be opposed to each other to sandwich the outside surfaces of the pair of side walls of the second connector housing which is formed with the shaft guiding slots, shaft engaging slots which are formed into a straight line shape on the inner surfaces of the pair of lever bodies so that when the pair of lever bodies are inserted and installed to the pair of side walls, both the lever supporting shafts, which are inserted through the shaft guiding slots, and the action receiving shafts are embedded in the shaft engaging slots, and a force point part which receives an operation force to make the lever bodies pivot around the lever supporting shafts, and
the fitting lever is pivoted while the lever supporting shafts and the action receiving shafts are engaged in the shaft engaging slots to make the connector housings move along the direction in which the connector housings are fitted with each other.

2. The lever connector according to claim 1, wherein the fitting lever includes insertion regulating protrusions on the inner surfaces of the lever bodies to regulate the insertion direction to the second connector housing,
the second connector housing includes first insertion guiding surfaces, second insertion guiding surfaces and guiding change parts at the pair of side walls which are formed with the shaft guiding slots,
the first insertion guiding surfaces are equipped so that when the fitting lever is inserted to and detached from the second connector housing while the first connector housing and the second connector housing are aligned at a fitting start position, the movement direction of the lever bodies is regulated to the direction of a straight line which links the lever supporting shafts in the shaft guiding slots and the action receiving shafts by the sliding contact of the insertion regulating protrusions,
the second insertion guiding surfaces are equipped so that when the fitting lever is inserted to and detached from the second connector housing while the first connector housing and the second connector housing are aligned at a fitting end position, the movement direction of the lever bodies is regulated to the direction of a straight line which links the lever supporting shafts in the shaft guiding slots and the action receiving shafts due to the sliding contact of the insertion regulating protrusions, and
the guiding change parts join the ends of the first insertion guiding surfaces and the ends of the second insertion guiding surfaces so that while the lever supporting shafts and the action receiving shafts are embedded in the shaft engaging slots, the insertion regulating protrusions can move back and forth between a first guiding end position after the insertion regulating protrusions pass the first insertion guiding surfaces and a second guiding end position after the insertion regulating protrusions pass the second insertion guiding surfaces.

3. The lever connector according to claim 2, wherein the guiding change parts have protrusion sliding surfaces against which the insertion regulating protrusions abut to regulate the fitting lever from moving away from the second connector housing.
